(19) United States
(12) Patent Application Publication
(10) Pub. No.: US 2023/0407793 A1
(43) Pub. Date: Dec. 21, 2023

(54) INSULATION ASSEMBLY FOR A GAS TURBINE ENGINE

(71) Applicant: General Electric Company, Schenectady, NY (US)

(72) Inventors: Mohan Kannaiah Raju, Bengaluru (IN); Subramani Adhiachari, Bengaluru (IN); Ravindra Shankar Ganiger, Bengaluru (IN); Arvind Namadevan, Bengaluru (IN); Prasant Bilaiya, Bengaluru (IN); Scott Alan Schimmels, Miamisburg, OH (US)

(21) Appl. No.: 18/068,031

(22) Filed: Dec. 19, 2022

(30) Foreign Application Priority Data
Jun. 15, 2022 (IN) 202211034229

(51) Int. Cl. F02C 7/24; F02C 7/22; F02C 7/06

(52) U.S. Cl. CPC F02C 7/24; F02C 7/222; F02C 7/06; F05D 2240/15; F05D 2260/231; F05D 2300/603

(57) ABSTRACT

An insulation assembly for use in a gas turbine engine is provided. The insulation assembly defines a hot side and an insulated side and includes: a heat shield layer positioned proximate the hot side; and a thermal absorption layer positioned proximate the insulated side, the thermal absorption layer comprising a phase change material, the insulation assembly defining an air gap positioned between the heat shield layer and the thermal absorption layer.

### PRIORITY INFORMATION

The present application claims priority to Indian Patent Application Number 202211034229 filed on Jun. 15, 2022.

### FIELD

The present disclosure relates to an insulation assembly for a gas turbine engine.

### BACKGROUND

A gas turbine engine generally includes a turbomachine and a rotor assembly. Gas turbine engines, such as turbofan engines, may be used for aircraft propulsion. In the case of a turbofan engine, the rotor assembly may be configured as a fan assembly. The turbomachine may generally include a compressor section, a combustion section, and a turbine section.

During certain operating conditions, the gas turbine engine may achieve relatively high temperatures. In particular, the combustion section and turbine section may achieve relatively high temperatures during high power output conditions, such as takeoff and climb. In certain engine configurations, it may be desirable to reduce a size of the turbomachine, such that more components and features may need to be positioned proximate the combustion section and turbine section.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of an exemplary gas turbine engine according to various embodiments of the present subject matter.

FIG. 2 is a schematic, close up view a turbine frame of a gas turbine engine in accordance with an exemplary aspect of the present disclosure.

FIG. 3 is a close-up, cross-sectional, schematic view of a lubrication oil tube in accordance with an exemplary aspect of the present disclosure, as viewed along a lengthwise direction of the lubrication oil tube.

FIG. 4 is a simplified graph of an amount of enthalpy added to a phase change material on a y-axis and a corresponding temperature of the phase change material on an x-axis.

FIG. 5 is a close-up, cross-sectional, schematic view of the exemplary lubrication oil tube of FIG. 3, as viewed along Line 4-4.

FIG. 6A is a table of example phase change materials suitable for inclusion in a thermal absorption layer of the present disclosure, and FIG. 6B is a table of example phase change materials suitable for inclusion in a thermal absorption layer of the present disclosure.

FIG. 7 is a table of insulation assemblies in accordance with various exemplary aspects of the present disclosure.

FIG. 8 is a schematic view of an insulation assembly in accordance with another exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The term “turbomachine” or “turbomachinery” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “low” and “high”, or their respective comparative degrees (e.g., —er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” of the engine.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

Approximating language, as used herein throughout the specification and claims, is applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “proximate” refers to being closer to one side or end than an opposite side or end.

The present disclosure is generally related to an insulation assembly for use in a gas turbine engine. The insulation assembly defines a hot side and an insulated side and includes: a heat shield layer positioned proximate the hot side; and a thermal absorption layer positioned proximate the insulated side. The insulation assembly further defines an air gap positioned between the heat shield layer and the thermal absorption layer. Moreover, the thermal absorption layer includes a phase change material.

In such a manner, the insulation assembly, in addition to providing several layers of thermal insulation, may also absorb heat for a duration of time to prevent a temperature of a fluid flow or substrate on the insulated side of the insulation layer from exceeding a degradation temperature of the fluid flow or substrate. In particular, the phase change material may define a melting point below the degradation temperature to allow the phase change material to absorb heat during, e.g., a high heat condition, reduce a likelihood or prevent the fluid flow or substrate from achieving the degradation temperature.

In certain exemplary embodiments, the insulation assembly may be configured as an insulation tube, such as a lubrication oil tube, such as an oil scavenge tube. In such a manner, the phase change material may absorb heat during a takeoff or climb operating condition where the oil scavenge tube may be exposed to an environment having a higher temperature than a degradation temperature of a lubrication oil being scavenged.

In other exemplary embodiments, the insulation assembly may be configured as an insulation tube, such as a fuel line providing fuel to a combustion section of the gas turbine engine. In such a manner, the phase change material may absorb heat during a shutdown condition to prevent the fuel remaining in the fuel line from coking.

In still other exemplary embodiments, the insulation assembly may be an insulation layer attached to a substrate, such as to an engine controller. In such a manner, the phase change material may absorb heat during a high temperature condition (e.g., takeoff or climb) where the engine controller may be exposed to an environment having a higher temperature than a degradation temperature of an engine controller. Such may allow for the engine controller to be positioned in a generally hotter area of the gas turbine engine.

Further, it will be appreciated that in one or more of the above embodiments, the insulation assembly may protect an aspect of the engine after a shutdown of the engine. For example, as will be appreciated, after an engine is shut down, heat from the engine may rise, increasing a temperature of one or more components at a top end of the engine relative to components at a bottom end of the engine; a phenomenon sometimes referred to as soakback. The insulation assembly may be configured to absorb the heat during such a situation and reduce a risk of damage to an underlying component or substance during such a situation. For example, when configured as an insulation tube, the insulation assembly may prevent coking of a fuel therein after an engine shuts down. When configured as an insulation layer on an engine controller, the insulation assembly may prevent the engine controller from exceeding a threshold temperature and damaging the components therein. Further, in still other embodiments, the insulation assembly may be utilized as an insulation tube for oil, lubrication fluid, thermal bus fluid, or other fluid in the engine. Additionally or alternatively the insulation assembly may be used as a protective layer for an electric machine in an undercowl area (i.e., an area outside a core air flowpath and inward of a casing surrounding a turbomachine of the engine), a fan or blower in the undercowl area, electric bus lines, power electronics, or other electrical devices.

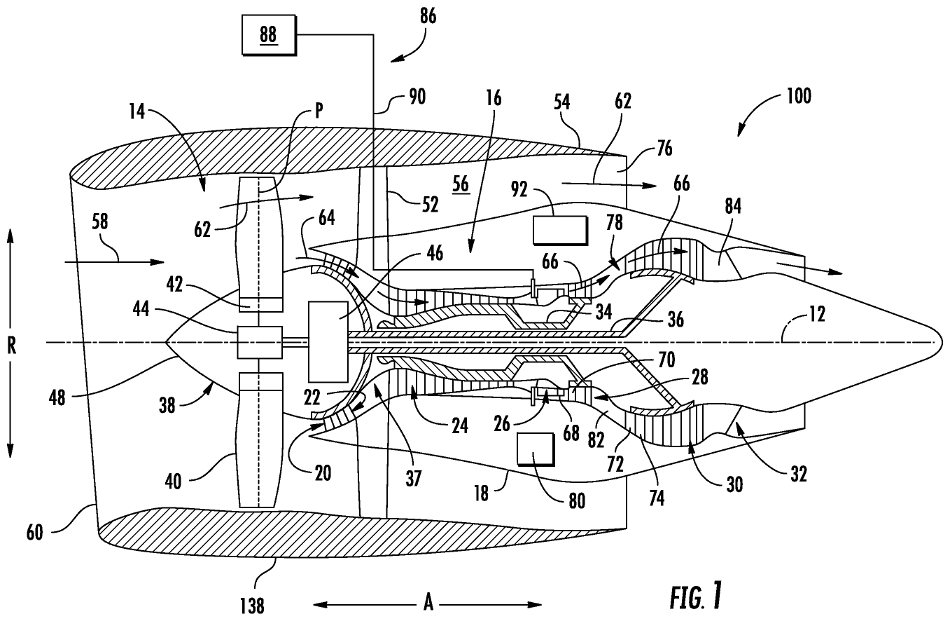

Referring now to the drawings, wherein identical numerals indicate the same elements throughout the figures, FIG. 1 is a schematic cross-sectional view of gas turbine engine 10 according to various embodiments of the present subject matter.

More particularly, for the embodiment of FIG. 1, the gas turbine engine is a high-bypass turbofan jet engine, referred to herein as a “gas turbine engine 10.” As shown in FIG. 1, gas turbine engine 10 defines an axial direction A (extending parallel to an axial centerline 12 provided for reference) and a radial direction R. In general, gas turbine engine 10 includes a fan section 14 and a core turbine engine 16 disposed downstream from the fan section 14.

Core turbine engine 16 depicted herein generally includes a substantially tubular outer casing 18 that defines an annular inlet 20. Outer casing 18 encases, in serial flow relationship, a compressor section including a booster or low pressure (“LP”) compressor 22 and a high pressure (“HP”) compressor 24; a combustion section 26; a turbine section including a high pressure (“HP”) turbine 28 and a low pressure (“LP”) turbine 30; and a jet exhaust nozzle section 32. In one example, the LP compressor 22 and the HP compressor 24 can be collectively referred to as a compressor section. In another example, the HP turbine 28 and the LP turbine 30 can be collectively referred to as the turbine section. A high pressure (“HP”) shaft or spool 34 drivingly connects the HP turbine 28 to the HP compressor 24. A low pressure (“LP”) shaft or spool 36 drivingly connects LP turbine 30 to LP compressor 22. The compressor section (e.g., the LP compressor 22 and the HP compressor 24), combustion section 26, the turbine section (e.g., the HP turbine 28 and the LP turbine 30 and jet exhaust nozzle section 32 together define a core air flowpath 37.

For the embodiment depicted, fan section 14 includes a variable pitch fan 38 having a plurality of fan blades 40 coupled to a disk 42 in a spaced apart manner. In one example, the variable pitch fan 38 can be referred to as a fan assembly. In another example, the disk 42 can be referred to as a fan disk. The disk 42 is configured to rotate about axial centerline 12 of the gas turbine engine 10 when installed in gas turbine engine 10. As depicted, fan blades 40 extend outwardly from the disk 42 generally along radial direction R. Each fan blade 40 is rotatable relative to the disk 42 about a pitch axis P by virtue of the fan blades 40 being operatively coupled to a suitable pitch change mechanism 44 configured to collectively vary the pitch of the fan blades 40 in unison. The fan blades 40, disk 42, and pitch change mechanism 44 are together rotatable about the axial centerline 12 by the LP shaft or spool 36 across a power gear box 46. The power gear box 46 includes a plurality of gears for adjusting a rotational speed of the fan 38 relative to the LP shaft or spool 36 to a more efficient rotational fan speed.

Referring still to the exemplary embodiment of FIG. 1, the disk 42 is covered by rotatable front the hub 48 aerodynamically contoured to promote an airflow through the plurality of the fan blades 40. Additionally, the fan section 14 includes an annular fan casing or the outer nacelle 50 that circumferentially surrounds the variable pitch fan 38 and/or at least a portion of the core turbine engine 16. It should be appreciated that the nacelle 50 may be configured to be supported relative to the core turbine engine 16 by a plurality of the circumferentially-spaced outlet guide vanes 52. Moreover, a downstream section 54 of the nacelle 50 may extend over an outer portion of the core turbine engine 16 so as to define a bypass airflow passage 56 therebetween.

During operation of the gas turbine engine 10, a volume of air 58 enters gas turbine engine 10 through an associated inlet 60 of nacelle 50 and/or fan section 14. As the volume of air 58 passes across fan blades 40, a first portion of the air 58 as indicated by arrows 62 is directed or routed into the bypass airflow passage 56 and a second portion of the air 58 as indicated by arrow 64 is directed or routed into the core air flowpath 37, or more specifically into LP compressor 22. The ratio between first portion of air 62 and second portion of air 64 is commonly known as a bypass ratio. The pressure of second portion of air 64 is then increased as it is routed through the high pressure (HP) compressor 24 and into combustion section 26, where second portion of air 64 is mixed with fuel and burned to provide combustion gases 66.

Combustion gases 66 are routed through HP turbine 28 where a portion of thermal and/or kinetic energy from combustion gases 66 is extracted via sequential stages of HP turbine stator vanes 68 that are coupled to outer casing 18 and HP turbine rotor blades 70 that are coupled to HP shaft or spool 34, thus causing HP shaft or spool 34 to rotate, thereby supporting operation of HP compressor 24. Combustion gases 66 are then routed through LP turbine 30 where a second portion of thermal and kinetic energy is extracted from combustion gases 66 via sequential stages of LP turbine stator vanes 72 that are coupled to outer casing 18 and LP turbine rotor blades 74 that are coupled to LP shaft or spool 36, thus causing LP shaft or spool 36 to rotate, thereby supporting operation of LP compressor 22 and/or rotation of fan 38.

Combustion gases 66 are subsequently routed through the jet exhaust nozzle section 32 of core turbine engine 16 to provide propulsive thrust. Simultaneously, the pressure of first portion of air 62 is substantially increased as first portion of air 62 is routed through bypass airflow passage 56 before first portion of air 62 is exhausted from a fan nozzle exhaust section 76 of gas turbine engine 10, also providing propulsive thrust. HP turbine 28, LP turbine 30, and jet exhaust nozzle section 32 at least partially define a hot gas path 78 for routing combustion gases 66 through core turbine engine 16.

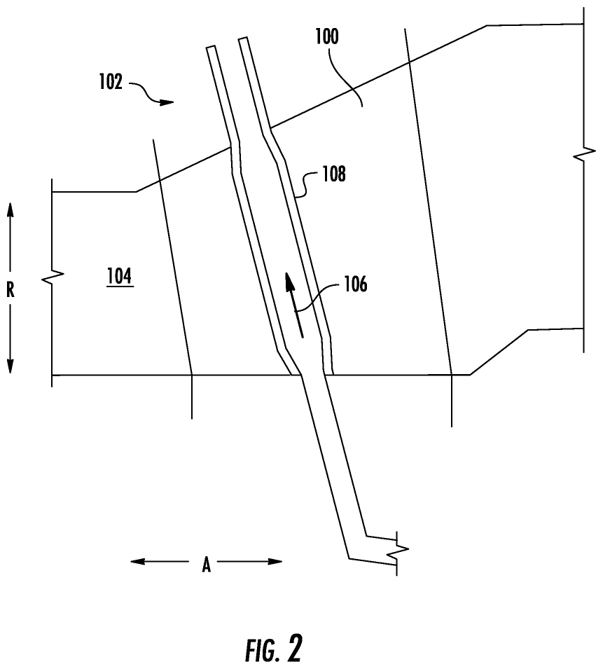

Further, as is depicted schematically, it will be appreciated that the gas turbine engine 10 depicted further includes a plurality of accessory systems. For example, the gas turbine engine 10 includes a lubrication oil system 80 configured to provide lubrication oil to one or more bearings, sumps, etc. for cooling and lubricating the one or more bearings, sumps, etc. In particular, the gas turbine engine 10 includes a turbine center frame 82 positioned between the HP turbine 28 and the LP turbine 30, and extending through the core air flowpath 37, as well as a turbine rear frame 84 positioned downstream of the LP turbine 30 and also extending through the core air flowpath 37. The lubrication oil system 80 may include one or more supply or scavenge lines extending therethrough (see, e.g., FIG. 2). In addition, the gas turbine engine 10 includes a fuel delivery system 86 having a fuel source 88 and one or more fuel lines 90 extending from the fuel source 88 to the combustion section 26. Moreover, the gas turbine engine 10 includes an engine controller 92. The engine controller 92 is, for the embodiment depicted, positioned in an under-cowl area (i.e., inward of the casing 18). The engine controller 92 may be a full authority digital engine control controller (“FADEC”), or any other suitable engine controller.

It should be appreciated, however, that the exemplary gas turbine engine 10 depicted in FIG. 1 is by way of example only, and that in other exemplary embodiments, gas turbine engine 10 may have any other suitable configuration. For example, the gas turbine engine 10 may be a direct drive engine (e.g., without the gearbox 46), may be a fixed-pitch engine (e.g., without the pitch change mechanism 44), may be an unducted turbofan engine (e.g., without nacelle 50), etc. It should also be appreciated, that in still other exemplary embodiments, aspects of the present disclosure may be incorporated into any other suitable gas turbine engine. For example, in other exemplary embodiments, aspects of the present disclosure may be incorporated into, e.g., a turboprop engine, a turboshaft engine, a turbojet engine, etc.

Referring now to FIG. 2, a schematic, close up view is provided of a turbine frame 100 of a gas turbine engine in accordance with an exemplary aspect of the present disclosure defining a radial direction R and an axial direction A. More specifically, the exemplary turbine frame 100 of FIG. 2 is configured as a turbine center frame, similar to the exemplary turbine center frame 82 described above with reference FIG. 1. In such a manner, it will be appreciated that the exemplary turbine frame 100 may be positioned downstream of a high-pressure turbine (such as HP turbine 28, see FIG. 1) and upstream of a low pressure turbine (such as LP turbine 30, see FIG. 1).

Moreover, as will be appreciated from the depiction in FIG. 2, the turbine frame 100 depicted is configured with a gas turbine engine including a lubrication oil system having a lubrication oil tube 102. The lubrication oil tube 102 is configured to extend through a working gas flowpath 104 of the gas turbine engine (e.g., a core air flowpath, such as the exemplary core air flowpath 37 described above with reference to FIG. 1) at a location downstream of a combustion section of the gas turbine engine (e.g., combustion section 26 depicted in FIG. 1). More specifically, for the embodiment depicted, the lubrication oil tube 102 is configured to extend through the working gas flowpath 104 within the turbine frame 100, such that the turbine frame 100 may provide a layer of protection from, e.g., combustion gases flowing through the working gas flowpath 104.

Moreover, for the exemplary embodiment depicted, the lubrication oil tube 102 is more particularly configured as an oil scavenge tube of the lubrication oil system. In such a manner, the lubrication oil tube 102 may be configured to receive a flow lubrication oil 106 from a sump or other location inward of the working gas flowpath 104 along the radial direction R and may provide the received lubrication oil tube 102 a location outward of the working gas flowpath 104 (e.g., a pump or other suction device) along the radial direction R. Notably, with such a configuration, the lubrication oil 106 may be at a relatively high temperature when received by the lubrication oil tube 102, and further may be extending through a relatively hot environment. In order to protect the lubrication oil 106 received through the lubrication oil tube 102 from achieving a temperature in excess of a degradation temperature for the lubrication oil 106 (e.g., a temperature at which the lubrication oil 106 begins to degrade, coke, or otherwise undergo undesirable chemical transformations), the exemplary embodiment the lubrication oil tube 102 depicted further includes an insulation assembly 108.

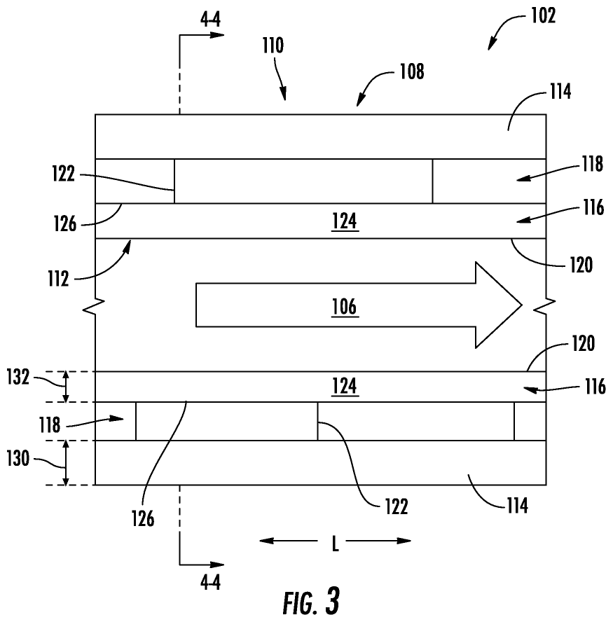

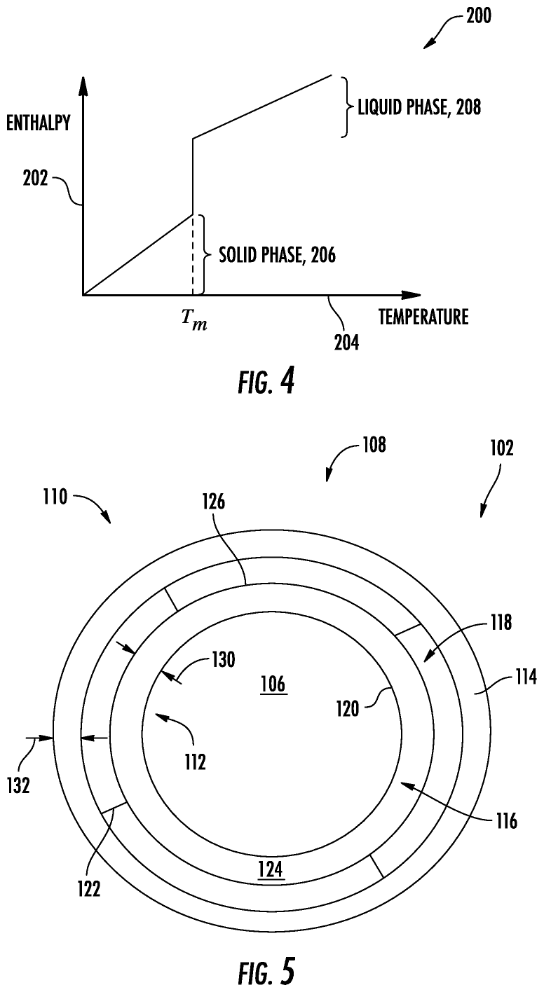

Referring now also to FIGS. 3 and 4, close-up, cross-sectional, schematic views of the lubrication oil tube 102 having the insulation assembly 108 are provided. FIG. 3 more specifically provides a close-up, cross-sectional, schematic view of the lubrication oil tube 102 as viewed along a lengthwise direction L of the lubrication oil tube 102, and FIG. 4 provides a close-up, cross-sectional, schematic view of the exemplary lubrication oil tube 102 of FIG. 3, as viewed along Line 4-4 in FIG. 3.

Referring to FIGS. 3 and 4, it will be appreciated that the insulation assembly 108 generally defines a hot side 110 and an insulated side 112. The hot side 110 is generally exposed to a relatively harsh environment, while the insulated side 112 is positioned opposite the hot side 110 and is generally exposed to, e.g., a fluid flow desired to be insulated from the relatively harsh environment (the flow of lubrication oil 106 in the present embodiment).

More specifically, for the embodiment depicted, the insulation assembly 108 generally includes a heat shield layer 114 positioned proximate the hot side 110 and a thermal absorption layer 116 positioned proximate the insulated side 112 (i.e., the heat shield layer 114 is positioned closer to the hot side 110 than the insulated side 112 and the thermal absorption layer 116 is positioned closer to the insulated side 112 than the hot side 110). The insulation assembly 108 defines an air gap 118 positioned between the heat shield layer 114 and the thermal absorption layer 116. Further, for the embodiment depicted, the insulation assembly 108 further includes an inner duct wall 120, which may contain the fluid flow therethrough (e.g., the lubrication oil 106 in the present embodiment).

Notably, for the embodiment depicted, the insulation assembly 108 is configured as an insulation tube. In such a manner, it will be appreciated that the inner duct wall 120 generally forms a fluid duct, which for the embodiment shown, is configured to facilitate the flow of lubrication oil 106 therethrough. Further, for the embodiment shown, the inner duct wall 120 is enclosed within the thermal absorption layer 116, such that the thermal absorption layer 116 extends completely around the inner duct wall 120 (see, particularly, FIG. 4). Similarly, the thermal absorption layer 116 is enclosed within the heat shield layer 114, such that the heat shield layer 114 extends completely around the thermal absorption layer 116 (see particular FIG. 4), and the air gap 118 is an air gap 118 positioned between the thermal absorption layer 116 and the heat shield layer 114.

The heat shield layer 114 may be formed of a material capable of withstanding relatively high temperatures, and further may be formed of a material having a relatively low heat transfer coefficient. In such a manner, the heat shield layer 114 may be configured to reduce the amount of heat transfer from a surrounding environment across the heat shield layer 114 towards the air gap 118 and thermal absorption layer 116. For example, the heat shield layer 114 may be formed of a carbon fiber composite material, an aerogel insulation layer formed on the substrate, or both.

Example carbon fiber composite materials that may be used to form the heat shield layer 114 include carbon bonded carbon fiber, ceramic matrix composites, etc. Example aerogel insulation materials that may be used to form the heat shield include silica aerogel.

More specifically, for the embodiment depicted, the heat shield layer 114 is formed of a composite fiber composite material.

Further, in order to further reduce a coefficient of heat transfer of the heat shield layer 114, the heat shield layer 114 may define a relatively high porosity. In particular, where the heat shield layer 114 is an aerogel, the heat shield layer 114 may define a porosity greater than about 50%. For example, the heat shield layer 114 may define a porosity greater than about 75%, such as greater than about 85%, such as greater than about 95%, and up to about 99.8%. As used herein, the term porosity, as used to describe the heat shield layer 114, generally refers to a ratio of solid material by volume within the heat shield layer 114 to a total volume of the heat shield layer 114.

Referring still to FIGS. 3 and 4, as noted above, the air gap 118 is defined between the heat shield layer 114 and the thermal absorption layer 116. The exemplary insulation assembly 108 depicted includes a plurality of offsets 122 extending between the heat shield layer 114 and the thermal absorption layer 116 to maintain the air gap 118. The plurality of offsets 122 may be any suitable material capable of withstanding anticipated temperatures for the insulation assembly 108, while providing minimal heat transfer between the heat shield layer 114 and the thermal absorption layer 116 through conductance. For example, the plurality of offsets 122 may be a plurality of wires extending between the heat shield layer 114 and the thermal absorption layer 116.

Notably, for the embodiment depicted, the air gap 118 is a closed volume fluidly isolated from the environment surrounding the insulation assembly 108. Such may provide for an increased thermal isolation for the insulated side 112 of the insulation assembly 108.

In certain embodiments, the air gap 118 may be filled with air, or alternatively, may be filled with any other suitable gas, such as an inert gas, nitrogen, etc.

Further, the thermal absorption layer 116 includes a phase change material 124 to allow for the thermal absorption layer 116 to absorb heat energy and prevent the insulated side 112 of the insulated layer from achieving a critical temperature for at least a period of time. In particular, for the embodiment depicted, the thermal absorption layer 116 may generally include an outer wall 12 and may be filled substantially completely with the phase change material 124 between the outer wall and the inner duct wall 120. The critical temperature, as used herein with respect to the thermal absorption layer 116, refers to a temperature above a phase change temperature, such as a melting temperature, of the phase change material 124 within the thermal absorption layer 116.

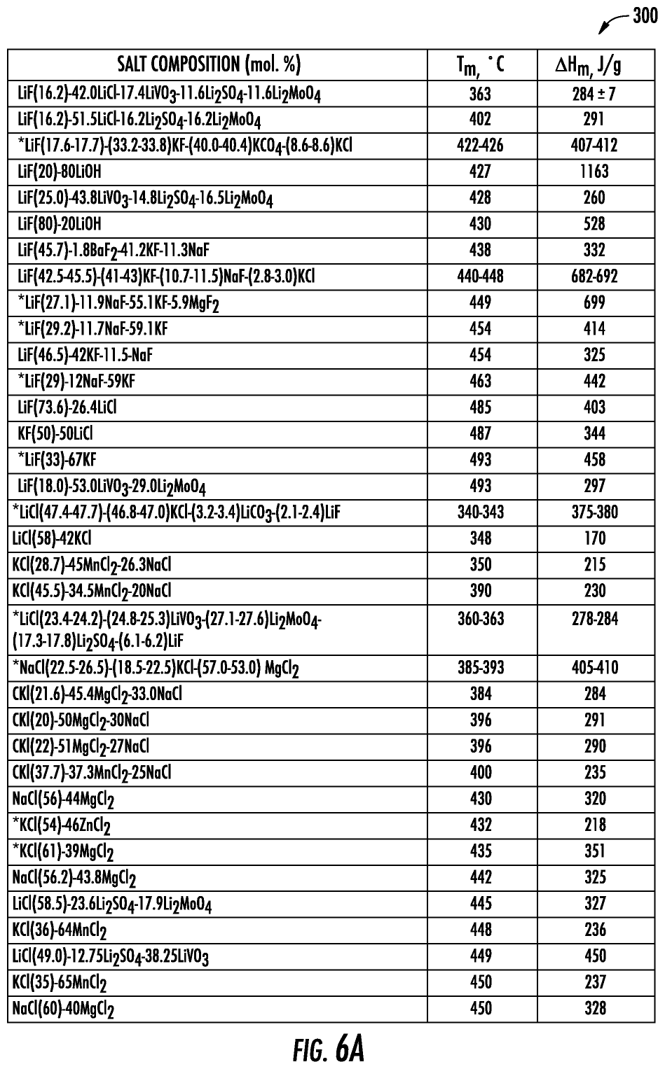

For example, referring briefly to FIG. 5, a simplified graph 200 is provided depicting an amount of enthalpy added to a phase change material on a y-axis 202 and a corresponding temperature of the phase change material on an x-axis 204. It will be appreciated that prior to the phase change material achieving a melting temperature, labeled T_{M}, for the phase change material (i.e., when the phase change material is in a solid phase, 206), a temperature of the phase change material increases with an increase in the amount of enthalpy added to the phase change material. Similarly, after the phase change material has achieved the melting temperature for the phase change material (i.e., when the phase change material is in a liquid phase, 208), the temperature of the phase change material also increases with the increase in the amount of enthalpy added to the phase change material. However, the phase change material is configured to absorb an amount of enthalpy when transitioning from the solid phase to the liquid phase without increasing in temperature during the transition.

In such a manner, it will be appreciated that the phase change material 124 positioned within the thermal absorption layer 116 may be configured to absorb an amount of enthalpy for a period of time without increasing in temperature past the critical temperature for the phase change material (e.g., the melting temperature) during the period of time. For example, in the embodiment of FIGS. 3 and 4, the phase change material 124 may be selected to define a critical temperature/melting temperature that is less than a degradation temperature of the lubrication oil 106 flowing through the locational tube. During, e.g., a relatively high operating temperature condition for the gas turbine engine, such as a takeoff or climb operating condition, where a temperature of the working gas flowpath surrounding the lubrication oil tube 102 may be at a peak, the insulation assembly 108, and more specifically, the phase change material 124 of the thermal absorption layer 116 may be configured to absorb an amount of enthalpy to prevent the lubrication oil 106 flowing through the lubrication tube from achieving a temperature in excess of the degradation temperature.

Referring particularly to FIGS. 3 and 4, it will be appreciated that the various layers of the insulation assembly 108 may be designed to provide a desired amount of thermal insulation and enthalpy absorption to allow for the insulated side 112 of the insulation assembly 108 to remain below a desired temperature during anticipated operating conditions of the gas turbine engine.

For example, in the least certain exemplary embodiments, the heat shield layer 114 defines a heat shield thickness 130, with the heat shield thickness 130 being between about 0.25 millimeters (“mm”) and about 20 mm. For example, the heat shield thickness 130 may be at least about 0.4 mm, such as at least about 0.5 mm, such as at least about 0.75 mm, such as at least about 1 mm, such as at least about 1.25 mm, such as at least about 1.5 mm, such as at least about 2 mm, and may be up to about 15 mm, such as up to about 12.5 mm, such as up to about 10 mm, such as up to about 7.5 mm, such as up to about 5 mm, such as up to about 3 mm, such as up to about 2.5 mm.

Similarly, for the embodiment depicted, the thermal absorption layer 116 defines a thermal absorption layer thickness 132 between about 0.25 mm and about 20 mm. For example, the thermal absorption layer thickness 132 may be at least about 0.4 mm, such as at least about 0.5 mm, such as at least about 0.75 mm, such as at least about 1 mm, such as at least about 1.25 mm, such as at least about 1.5 mm, such as at least about 2 mm, and may be up to about 15 mm, such as up to about 12.5 mm, such as up to about 10 mm, such as up to about 7.5 mm, such as up to about 5 mm, such as up to about 3 mm, such as up to about 2.5 mm.

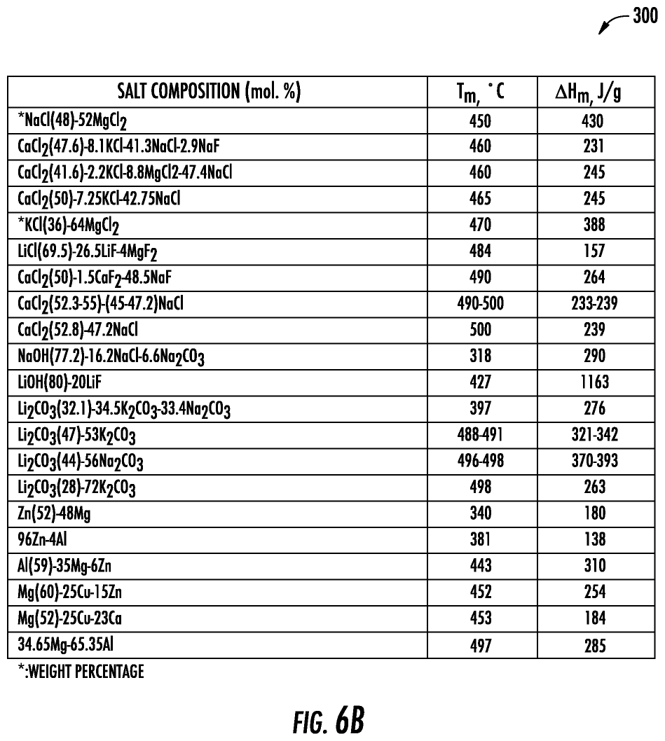

Moreover, the phase change material 124 within the thermal absorption layer 116 may be chosen to define a melting point (or melting temperature) specific for the application. In at least certain exemplary embodiments, the phase change material 124 may define a melting point between about 200 degrees Celsius and about 750 degrees Celsius, such as between about 300 degrees Celsius and about 500 degrees Celsius. Further, in at least certain exemplary embodiments, the phase change material 124 further defines an enthalpy of melting between about 150 joules per gram (J/g) and about 1200 J/g, such as between about 250 J/g and about 1000 J/g, such as between about 300 J/g and about 700 J/g. As used herein, the term “enthalpy of melting” refers to the amount of heat required to melt the phase change material 124 completely. Example phase change materials suitable for inclusion in the thermal absorption layer 116 are attached hereto as a table 300 in FIGS. 6A and 6B. It will be appreciated that the exemplary phase change materials included in this table are provided by way of example only, and in other embodiments, any other suitable phase change materials may be utilized.

Notably, depending on the application of the insulation assembly 108, it may not be necessary to include both a relatively high heat shield thickness 130 and a relatively high thermal absorption layer thickness 132. For example, in certain exemplary embodiments, a sum of the heat shield thickness 130 and the thermal absorption layer thickness 132 may be less than about 10 mm, such as lesson about 7.5 mm, such as lesson about 5 mm, such as lesson about 3 mm.

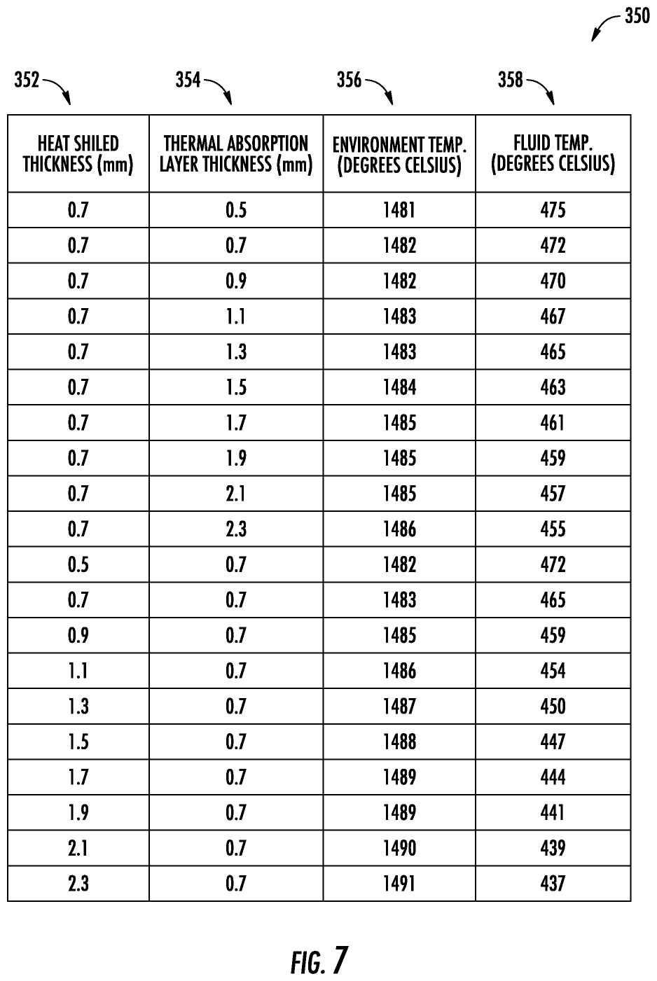

Examples of one exemplary application of the insulation assembly 108 showing how a desired result may be achieved by varying the heat shield thickness 130 of the heat shield layer 114 and the thermal absorption layer thickness 132 of the thermal absorption layer 116 are provided in FIG. 7. More specifically, FIG. 7 provides a table 350 of examples of one exemplary aspect of the present disclosure, showing example heat shield layer thicknesses in column 352, example thermal absorption layer thicknesses in column 354, example environmental temperatures in column 356, and example fluid temperatures (on the insulated side 112 of the insulation assembly 108) in column 358.

It will be appreciated, however, that the examples provided in FIG. 7 are provided by way of example only.

It will further be appreciated that the exemplary insulation assembly 108 described above is provided by way of example only. In other exemplary embodiments, the insulation assembly 108 may, for example, be applied to any other suitable fluid flow duct in, to, or through the gas turbine engine. For example, referring briefly back to FIG. 1, in certain exemplary embodiments, the insulation assembly 108 may be utilized with the fuel delivery system 86, and more specifically, may be configured as an insulation tube configured to provide for a fuel flow through the gas turbine engine 10 (e.g., the insulation assembly 108 may be configured as an insulation tube, with the insulation tube being a fuel line 90).

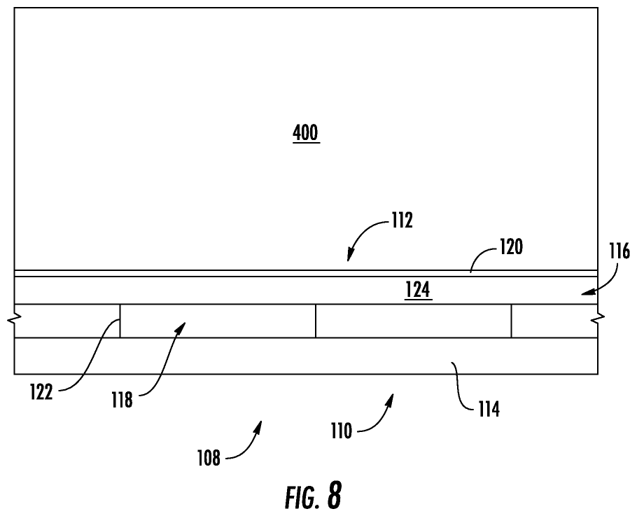

Moreover, in still other exemplary embodiments, the insulation assembly 108 may not be configured as a fuel tube. For example, referring now briefly to FIG. 8, an insulation assembly 108 in accordance with another exemplary aspect of the present disclosure is provided. For the exemplary embodiment of FIG. 8, the insulation assembly 108 is configured as an insulation layer or cover configured to be applied to one or more components within a gas turbine engine to maintain the one or more components below a critical temperature. In particular, for the exemplary embodiment of FIG. 8, the insulation assembly 108 is applied to a controller, and more specifically, is applied to an engine controller 400 similar to the exemplary engine controller 92 described above with reference FIG. 1. It will be appreciated that the exemplary insulation assembly 108 of FIG. 8 may be configured in substantially the same manner as exemplary insulation assembly 108 described above with reference to FIGS. 2 through 7.

For example, the exemplary insulation assembly 108 depicted generally defines a hot side 110 and an insulated side 112, and includes a heat shield layer 114 positioned proximate the hot side 110 and a thermal absorption layer 116 position proximate the insulated side 112. The insulation assembly 108 defines an air gap 118 with the heat shield layer 114, positioned between the heat shield layer 114 and the insulation assembly 108. Moreover, the exemplary thermal absorption layer 116 generally includes a phase change material 124.

In such a manner, the insulation assembly 108 of the exemplary embodiment of FIG. 8 may prevent the engine controller 400 from achieving the critical temperature during an operating condition of the gas turbine engine.

Further aspects are provided by the subject matter of the following clauses:

An insulation assembly for use in a gas turbine engine, the insulation assembly defining a hot side and an insulated side and comprising: a heat shield layer positioned proximate the hot side; and a thermal absorption layer positioned proximate the insulated side, the thermal absorption layer comprising a phase change material, the insulation assembly defining an air gap positioned between the heat shield layer and the thermal absorption layer.

The insulation assembly of one or more of the preceding clauses, wherein the heat shield layer is a carbon fiber composite material defining a porosity greater than about 50%, an aerogel insulation assembly formed on a substrate, or both.

The insulation assembly of one or more of the preceding clauses, wherein the heat shield layer defines a heat shield thickness less than about 3 millimeters, and wherein the thermal absorption layer defines a thermal absorption layer thickness less than about 3 millimeters.

The insulation assembly of one or more of the preceding clauses, wherein the heat shield layer defines a heat shield thickness, wherein the thermal absorption layer defines a thermal absorption layer thickness, and wherein a sum of the heat shield thickness and the thermal absorption layer thickness is less than about 3 millimeters.

The insulation assembly of one or more of the preceding clauses, wherein the phase change material defines a melting point between about 300 degrees Celsius and about 500 degrees Celsius, and wherein the phase change material further defines an enthalpy of melting between about 150 joules per gram (J/g) ad about 1200 J/g.

The insulation assembly of one or more of the preceding clauses, wherein the insulation assembly is an insulation tube further comprising an inner duct wall.

The insulation assembly of one or more of the preceding clauses, wherein the inner duct wall is enclosed within the thermal absorption layer, wherein the thermal absorption layer in enclosed within the heat shield layer, and wherein the air gap is a substantially annular air gap.

The insulation assembly of one or more of the preceding clauses, wherein the gas turbine engine defines a working gas flowpath and comprises a combustion section, and wherein the insulation tube is configured to extend through the working gas flowpath at a location downstream of the combustion section.

The insulation assembly of one or more of the preceding clauses, wherein the insulation tube is an oil scavenge tube.

The insulation assembly of one or more of the preceding clauses, wherein the insulation tube is a fuel line.

The insulation assembly of one or more of the preceding clauses, wherein the inner duct wall defines a fluid flowpath configured to flow a fluid therethrough defining a degradation temperature, wherein the phase change material defines a melting point less than the degradation temperature.

The insulation assembly of one or more of the preceding clauses, wherein the gas turbine engine comprises a turbomachine, a casing enclosing at least in part the turbomachine and defining an undercowl area, and a controller positioned within the undercowl area, and wherein the insulation assembly is configured to be positioned on the controller.

A gas turbine engine comprising: a turbomachine; a casing enclosing at least in part the turbomachine and defining an undercowl area; and an insulation assembly positioned within the undercowl area, the insulation assembly defining a hot side and an insulated side and comprising: a heat shield layer positioned proximate the hot side; and a thermal absorption layer positioned proximate the insulated side, the thermal absorption layer comprising a phase change material, the insulation assembly defining an air gap positioned between the heat shield layer and the thermal absorption layer.

The gas turbine engine of one or more of the preceding clauses, wherein the heat shield layer is a carbon fiber composite material defining a porosity greater than about 50%, an aerogel insulation assembly formed on a substrate, or both.

The gas turbine engine of one or more of the preceding clauses, wherein the heat shield layer defines a heat shield thickness less than about 3 millimeters, and wherein the thermal absorption layer defines a thermal absorption layer thickness less than about 3 millimeters.

The gas turbine engine of one or more of the preceding clauses, wherein the phase change material defines a melting point between about 300 degrees Celsius and about 500 degrees Celsius, and wherein the phase change material further defines an enthalpy of melting between about 150 joules per gram (J/g) ad about 1200 J/g.

The gas turbine engine of one or more of the preceding clauses, wherein the insulation assembly is an insulation tube further comprising an inner duct wall.

The gas turbine engine of one or more of the preceding clauses, wherein the turbomachine defines a working gas flowpath and comprises a combustion section, and wherein the insulation tube is configured to extend through the working gas flowpath at a location downstream of the combustion section.

The gas turbine engine of one or more of the preceding clauses, wherein the turbomachine comprises a turbine section and a turbine frame extending through the working gas flowpath within the turbine section, and wherein the insulation tube is an oil scavenge tube extending through the turbine frame.

The gas turbine engine of one or more of the preceding clauses, wherein the insulation tube is a fuel line.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. An insulation assembly for use in a gas turbine engine, the insulation assembly defining a hot side and an insulated side and comprising:
a heat shield layer positioned proximate the hot side; and
a thermal absorption layer positioned proximate the insulated side, the thermal absorption layer comprising a phase change material, the insulation assembly defining an air gap positioned between the heat shield layer and the thermal absorption layer.

2. The insulation assembly of claim 1, wherein the heat shield layer is a carbon fiber composite material defining a porosity greater than about 50%, an aerogel insulation assembly formed on a substrate, or both.

3. The insulation assembly of claim 1, wherein the heat shield layer defines a heat shield thickness less than about 3 millimeters, and wherein the thermal absorption layer defines a thermal absorption layer thickness less than about 3 millimeters.

4. The insulation assembly of claim 1, wherein the heat shield layer defines a heat shield thickness, wherein the thermal absorption layer defines a thermal absorption layer thickness, and wherein a sum of the heat shield thickness and the thermal absorption layer thickness is less than about 3 millimeters.

5. The insulation assembly of claim 1, wherein the phase change material defines a melting point between about 300 degrees Celsius and about 500 degrees Celsius, and wherein the phase change material further defines an enthalpy of melting between about 150 joules per gram (J/g) ad about 1200 J/g.

6. The insulation assembly of claim 1, wherein the insulation assembly is an insulation tube further comprising an inner duct wall.

7. The insulation assembly of claim 6, wherein the inner duct wall is enclosed within the thermal absorption layer, wherein the thermal absorption layer in enclosed within the heat shield layer, and wherein the air gap is a substantially annular air gap.

8. The insulation assembly of claim 6, wherein the gas turbine engine defines a working gas flowpath and comprises a combustion section, and wherein the insulation tube is configured to extend through the working gas flowpath at a location downstream of the combustion section.

9. The insulation assembly of claim 8, wherein the insulation tube is an oil scavenge tube.

10. The insulation assembly of claim 6, wherein the insulation tube is a fuel line.

11. The insulation assembly of claim 6, wherein the inner duct wall defines a fluid flowpath configured to flow a fluid therethrough defining a degradation temperature, wherein the phase change material defines a melting point less than the degradation temperature.

12. The insulation assembly of claim 1, wherein the gas turbine engine comprises a turbomachine, a casing enclosing at least in part the turbomachine and defining an undercowl area, and a controller positioned within the undercowl area, and wherein the insulation assembly is configured to be positioned on the controller.

13. A gas turbine engine comprising:
a turbomachine;
a casing enclosing at least in part the turbomachine and defining an undercowl area; and
an insulation assembly positioned within the undercowl area, the insulation assembly defining a hot side and an insulated side and comprising:
a heat shield layer positioned proximate the hot side; and
a thermal absorption layer positioned proximate the insulated side, the thermal absorption layer comprising a phase change material, the insulation assembly defining an air gap positioned between the heat shield layer and the thermal absorption layer.

14. The gas turbine engine of claim 13, wherein the heat shield layer is a carbon fiber composite material defining a porosity greater than about 50%, an aerogel insulation assembly formed on a substrate, or both.

15. The gas turbine engine of claim 13, wherein the heat shield layer defines a heat shield thickness less than about 3 millimeters, and wherein the thermal absorption layer defines a thermal absorption layer thickness less than about 3 millimeters.

16. The gas turbine engine of claim 13, wherein the phase change material defines a melting point between about 300 degrees Celsius and about 500 degrees Celsius, and wherein the phase change material further defines an enthalpy of melting between about 150 joules per gram (J/g) ad about 1200 J/g.

17. The gas turbine engine of claim 13, wherein the insulation assembly is an insulation tube further comprising an inner duct wall.

18. The gas turbine engine of claim 17, wherein the turbomachine defines a working gas flowpath and comprises a combustion section, and wherein the insulation tube is configured to extend through the working gas flowpath at a location downstream of the combustion section.

19. The gas turbine engine of claim 18, wherein the turbomachine comprises a turbine section and a turbine frame extending through the working gas flowpath within the turbine section, and wherein the insulation tube is an oil scavenge tube extending through the turbine frame.

20. The gas turbine engine of claim 17, wherein the insulation tube is a fuel line.
